(19) United States
(12) Patent Application Publication
(10) Pub. No.: US 2026/0246164 A1
(43) Pub. Date: Aug. 20, 2026

(54) ELECTRICAL JUNCTION WITH INSULATED SCREW CONNECTION FOR BUSBARS

(71) Applicant: Aptiv Technologies AG, Schaffhausen (CH)

(72) Inventors: Mélanie GUILLANTON, EPERNON (FR); Tanuraj BHATTACHARJEE, Rangirkhari (IN)

(21) Appl. No.: 19/459,308

(22) Filed: Jan. 26, 2026

(30) Foreign Application Priority Data
Feb. 16, 2025 (EP) 25158160.9

(51) Int. Cl. H01R 4/34; H01R 25/16; H01R 43/26

(52) U.S. Cl. CPC H01R 4/34; H01R 25/162; H01R 43/26

(57) ABSTRACT

An electrical junction includes a housing, a screw, and a nut. The housing receives ends of upper and lower busbars, each having a hole along aligned axes. The screw engages both holes and screws into the nut, pressing the busbars together. A cylindrical insulator is inserted into both holes, receiving the screw and inhibiting contact between the busbars and the screw, thereby electrically isolating the busbars from the screw. This configuration enables a secure and insulated electrical connection between the upper and lower busbars.

### CROSS-REFERENCE TO RELATED APPLICATION

This application claims the benefit of and priority to European Application No. 25158160.9 filed with the European Patent Office on February 16, 2025, the contents of which are incorporated by reference herein.

### TECHNICAL FIELD

The present disclosure generally relates to an electrical junction with an insulated screw connection for busbars.

### BACKGROUND

A busbar is an electrical conductor intended to transport a high intensity of current. To do so, it is made of a metallic material, such as copper or aluminium. A busbar is a rigid part component.

In order to connect or disconnect two busbars, a junction is used. Since high current is carried, a substantial contacting surface is needed, and the contact must be mechanically secured. This is usually done by screwing the two busbars together.

For safety reasons, any part of a busbar must be protected according to IP2X finger-safe protection requirements, that is, protected to preclude any contact between a conductive surface of a busbar and a body part of a living creature.

Away from a junction, this is generally obtained by an insulating sheath wholly surrounding the busbar. At a junction, however, any such insulator must be locally removed in order to ensure electrical contact between the two busbars.

Accordingly, a junction must provide IP2X protection of the contact. Since the screw and the nut are metallic, to provide a sufficient contact force, and in contact with the busbars to press them one against another, they are usually carrying current. According to prior art, junctions place the screw and nut under current. This implies a protection of the screw, e.g. by over-molding it. Such an approach is costly and bulky.

### SUMMARY

This disclosure provides an alternate approach, where the screw and nut are not in electrical contact with any of the busbars, thus avoiding any need to protect the screw or the nut.

In some aspects, the techniques described herein relate to an electrical junction, including a housing, a screw, and a nut. The housing is able to receive an end of an upper busbar including a first hole along a first axis and an end of a lower busbar including a second hole along a second axis aligned with the first axis of the first hole, when busbars are engaged into the housing, both busbars being assembled by the screw engaging both holes and screwing the nut, so as to press busbars one against the other. The junction further includes a first insulator, generally cylindrical to be inserted in both holes and hollow to receive the screw, in order to inhibit any contact between the busbars and the screw.

In some aspects, the techniques described herein relate to an electrical junction, further including a second insulator including a third hole to be engaged by the screw, disposed between the nut and the lower busbar, in order to inhibit any contact between the lower busbar and the nut.

In some aspects, the techniques described herein relate to an electrical junction, wherein the first insulator and the second insulator are made of a PPSGF40 plastic material.

In some aspects, the techniques described herein relate to an electrical junction, wherein the housing includes a generally cylindrical chamber with a top opening, able to receive the first insulator, the first insulator being able to slide with respect to the chamber, along the chamber's axis, parallel to the holes' axis, when busbars are engaged into the housing, so that the first insulator can engage the holes, between an out position where the first insulator is removed from the housing and does not engage any of the holes, an intermediate position where the first insulator engages only the first hole of the upper busbar, and a final position where the first insulator engages both holes.

In some aspects, the techniques described herein relate to an electrical junction, wherein the housing and the first insulator include at least one latch and as many corresponding pits (9i, 9f) able to selectively engage or disengage, in order to lock the first insulator with respect to the housing in the intermediate position and/or in the final position.

In some aspects, the techniques described herein relate to an electrical junction, wherein the bottom of the chamber is able to tightly receive the nut so as to inhibit its rotation along its axis, and the housing and the second insulator include at least one latch and as many corresponding pits able to selectively engage or disengage, to lock or unlock the second insulator with respect to the housing, in order to secure the nut in the bottom of the chamber.

In some aspects, the techniques described herein relate to an electrical junction, wherein the housing further includes an upper slot able to receive the end of the upper busbar, the upper slot being generally perpendicular to the axis and including at least one latch able to selectively lock/unlock the end of the upper busbar, when fully inserted in the upper slot and a lower slot able to receive the end of the lower busbar, the lower slot being generally perpendicular to the axis and including at least one latch able to selectively lock/unlock the end of the lower busbar, when fully inserted in the lower slot.

In some aspects, the techniques described herein relate to an electrical junction, wherein when the upper busbar is fully inserted in the upper slot, the first axis of the first hole is aligned with the axis, and when the lower busbar is fully inserted in the lower slot, the second axis of the second hole is aligned with the axis.

In some aspects, the techniques described herein relate to a method of assembling an electrical junction, including: inserting a nut into the bottom of the chamber; placing and locking a second insulator in the chamber; inserting an upper busbar into the upper slot of the housing; placing a first insulator in the chamber and sliding it to the intermediate position, in order to secure the upper busbar; inserting a lower busbar into the lower slot of the housing; sliding the first insulator to the final position, in order to secure the upper busbar and the lower busbar; and inserting a screw into the first insulator and screwing it into the nut.

### BRIEF DESCRIPTION OF THE DRAWINGS

Other features, details, and advantages of the disclosure will become more apparent from the detailed illustrating description given hereafter with respect to the drawings on which:

FIG. 1 shows an isometric view of an electrical junction with both busbars according to some embodiments.

FIG. 2 shows an exploded isometric view of an electrical junction according to some embodiments.

FIG. 3 shows an isometric view of a housing according to some embodiments.

FIG. 4 shows a cross-section view of a junction with a first insulator in intermediate position according to some embodiments.

FIG. 5 shows a cross-section view of a junction with a first insulator in final position according to some embodiments.

FIG. 6 shows a top view of a second insulator locked in position according to some embodiments.

FIG. 7 shows a top cross-section view of a housing with a first busbar according to some embodiments.

FIG. 8 shows a side cross-section view of a housing with a first busbar according to some embodiments.

FIG. 9 shows an isometric view of a housing and a first busbar before its insertion according to some embodiments.

FIG. 10 shows an isometric view of a housing and a first busbar after its insertion and before its locking according to some embodiments.

FIG. 11 shows an isometric view of a housing and a first busbar after its locking and a second busbar before its insertion according to some embodiments.

FIG. 12 shows an isometric view of a housing and a second busbar after its insertion and after its locking according to some embodiments.

### DETAILED DESCRIPTION

One object of the disclosure is an electrical junction 1. The electrical junction 1 comprises a housing 2, a screw 3 and a nut 4. The housing 2 is conformed to receive an end of an upper busbar B1 and an end of a lower busbar B2. The upper busbar B1 comprises a first hole H1 along a first axis A1. The lower busbar B2 comprises a second hole H2 along a second axis A2, aligned with the first axis A1, when busbars B1, B2 are engaged into the housing 2.

Once engaged into the housing 2, both busbars B1, B2 are assembled by the screw 3 engaging both holes H1, H2 and screwing the nut 4. When the screw 3 is tightened toward the nut 4, it presses busbars B1, B2 one against the other, in order to guarantee an electrical contact between them.

When the screw 3 and the nut 4 are tightened, they would normally be in contact with either one of the busbars B1, B2. Since the screw 3 and the nut 4 are metallic, they would normally be under current when busbars B1, B2 are.

However, according to one feature, junction 1 further comprises a first insulator 5. The first insulator 5 exhibits a generally cylindrical shape. Accordingly, the first insulator 5 can be inserted in both holes H1, H2. Furthermore, the first insulator 5 is hollow and can receive the screw 3. Since the first insulator 5 is placed between the screw 3 and the busbars B1, B2, it advantageously inhibits any contact between the busbars B1, B2 and the screw 3. Since the first insulator 5 is made of an insulating material, such as plastic, even when a current runs through busbars B1, B2, the screw 3 is not under current.

The IP2X protection thus becomes simpler. Busbars B1, B2 are still to be protected against any possible contact with a body part. This is obtained through housing 2 surrounding both busbars’ ends, where busbars B1, B2 are without a sheath. But the screw 3 does not have to be protected, since it cannot be under current.

As illustrated, the first insulator 5 comprises a first tubular lower part 5b. The lower part 5b is intended to engage both holes H1, H2 and be engaged by screw 3. The first insulator 5 comprises a second tubular upper part 5a. The upper part 5a is concentric with the lower part 5b. The upper part 5a is intended to surround the head of the screw 3. Between these two parts 5a, 5b, the first insulator 5 further comprises a shoulder 5c, allowing the head of the screw 3 to press against the upper busbar B1 when screwed, without touching it.

According to another feature, the electrical junction 1 further comprises a second insulator 6. The second insulator 6 is generally flat-shaped. It comprises a third hole 7. The third hole 7 is able to receive the screw 3. Since the second insulator 6 is disposed between the nut 4 and the closest busbar, that is, the lower busbar B2, it advantageously inhibits any contact between the lower busbar B2 and the nut 4. Since the second insulator 6 is made of an insulating material, such as plastic, even when a current runs through busbars B1, B2, the nut 4 is not under current.

Both insulators 5, 6 can be made of any insulating material. According to another feature, they can advantageously be made of a PPSGF40 plastic material. Such a PPSGF40 material exhibits high dimensional stability, very good chemical resistance, good electrical and thermal insulation.

In this application, the important property of PPSGF40 is not being sensitive to dimension variation under temperature and time. This is advantageous, because insulators 5, 6 are submitted to a tightening torque, when screw 3 is tightened. The property avoids losing torque after heating or ageing of the insulators 5, 6.

According to another feature, housing 2 comprises a generally cylindrical chamber 10. The chamber 10 comprises a top opening. The chamber 10 is preferably closed at its bottom 10b. The chamber 10 is able to slidably receive the first insulator 5. The first insulator 5 is able to slide with respect to the chamber 10, along the generally vertical chamber’s axis A. When busbars B1, B2 are fully engaged into the housing 2, the chamber’s axis A is aligned to the holes’ axis A1, A2. Accordingly, the first insulator 5 can engage the holes H1, H2. The triple axis also corresponds to the screw’s 3 axis.

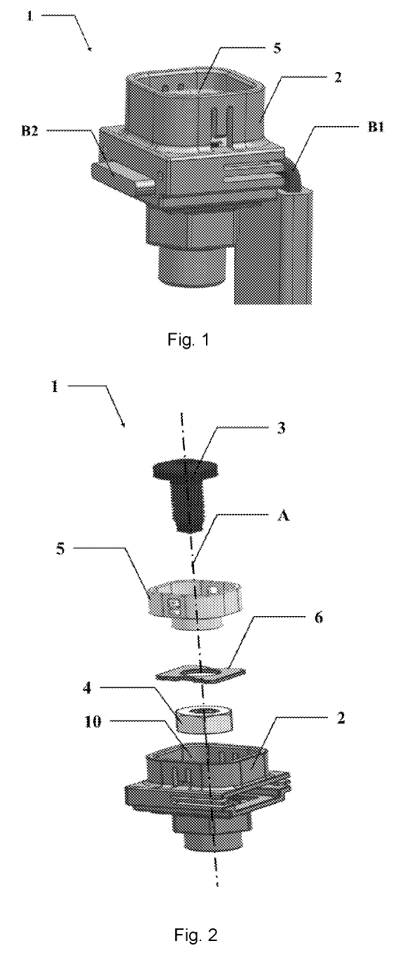

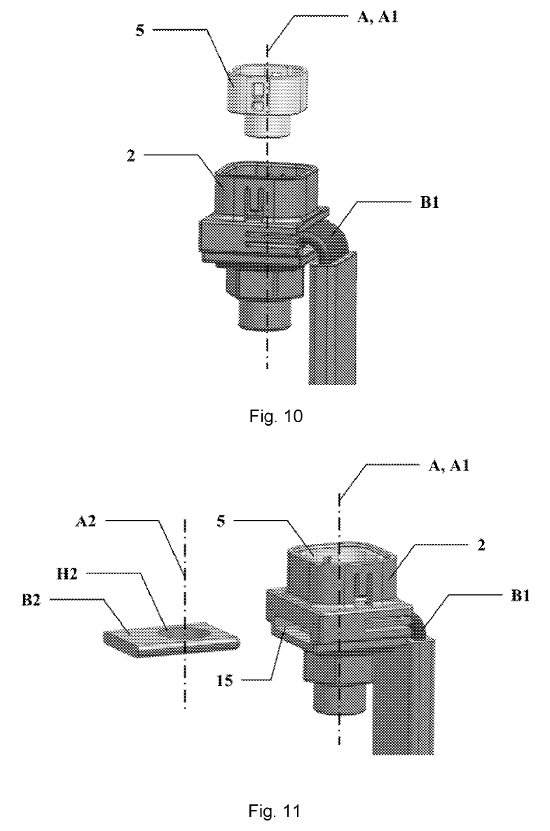

The first insulator 5 can slide along the chamber 10 through three different positions. A first position is an out position where the first insulator 5 is out of the housing 2. In this out position, more particularly shown in FIGS. 2, 10, the first insulator 5 does not engage any of the holes H1, H2.

A second position is an intermediate position. In this intermediate position, more particularly shown in FIGS. 4, 11, the first insulator 5 engages only the first hole H1 of the upper busbar B1.

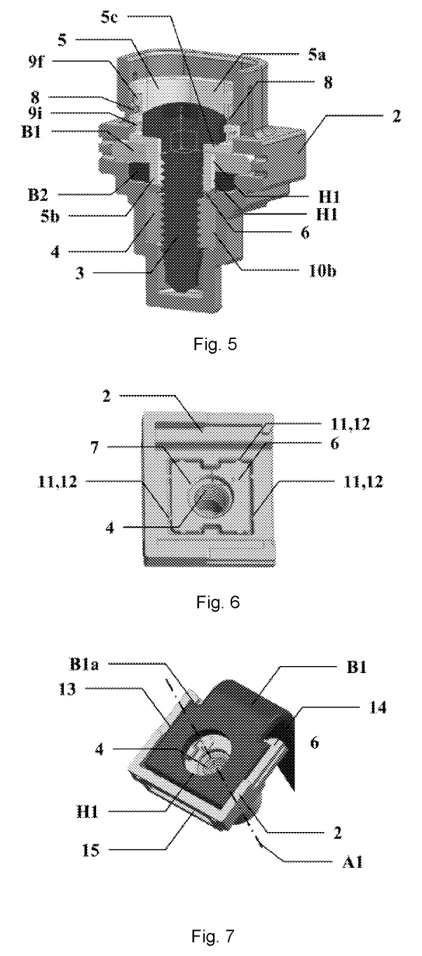

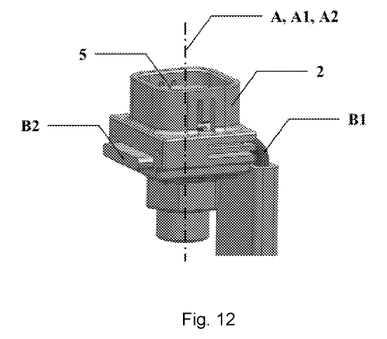

A third position is a final position. In this final position, more particularly shown in FIGS. 5, 12, the first insulator 5 engages both holes H1, H2.

According to another feature, the housing 2 and the first insulator 5 comprise at least one latch 8 and as many corresponding pits 9, 9i, 9f as are able to selectively engage/disengage. When the latch 8 is engaged in the corresponding pit 9, 9i, 9f, the first insulator 5 is locked with respect to the housing 2, respectively in the intermediate position or in the final position.

As illustrated, latch 8 is held by the housing 2 and pit 9, 9i, 9f is drilled in the first insulator 5. A latch 8 comprises an end that can selectively engage a pit 9, 9i, 9f. A latch 8 is elastic. At rest, a latch 8 engages a pit 9, 9i, 9f. Its elasticity allows it to disengage. A latch 8 is thus engaged/locked by default.

The first insulator 5 comprises a first series of pits 9i corresponding and defining the intermediate position. The first insulator 5 further comprises a second series of pits 9f corresponding and defining the final position.

Alternately, a latch 8 can be held by the first insulator 5 and a pit 9, 9i, 9f can be drilled in the housing 2; a combination of both is also possible.

According to another feature, the bottom 10b of chamber 10 is able to tightly receive the nut 4 so as to inhibit its rotation along its axis A. E.g., as illustrated, for a hexagonal nut 4, the bottom 10b of chamber 10 is advantageously hexagonally shaped and tight with respect to the nut 4.

According to another feature, the housing 2 and the second insulator 6 comprise at least one latch 11 and as many corresponding pits 12 able to selectively engage/disengage. This allows selectively locking/unlocking the second insulator 6 with respect to the housing 2. This guarantees a closure of the bottom 10b of the chamber 10. The closure secures the nut 4 in the chamber 10. Due to the elasticity of the material of the latch 11, the second insulator 6 can be selectively locked and unlocked. Latches 11 can be located either on the second insulator 6 or on the housing 2. As illustrated, latches 11 can be located on both. The same applies to the corresponding pits 12.

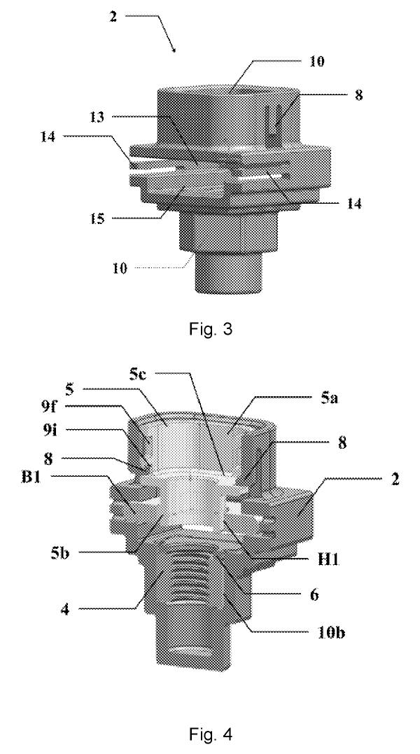

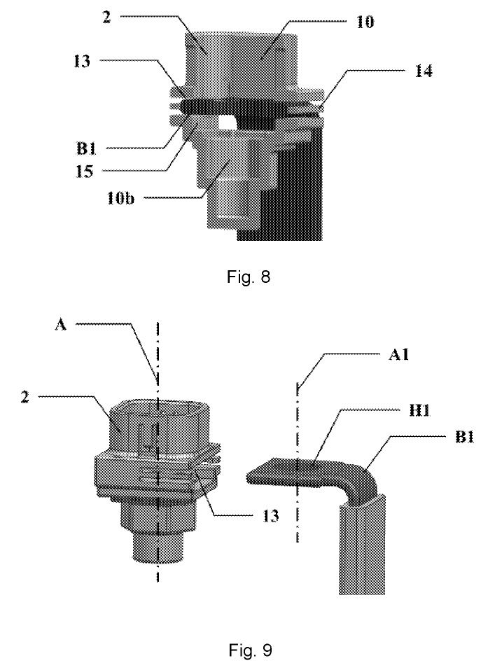

According to another feature, more particularly illustrated in FIGS. 3, 7, 8, 9, 11, the housing 2 comprises an upper slot 13 and a lower slot 15.

The upper slot 13 is able to receive the end of the upper busbar B1. The upper slot 13 is generally perpendicular to the chamber’s axis A. The upper slot 13 preferably comprises at least one latch 14 able to selectively lock/unlock the end of the upper busbar B1, when the upper busbar B1 is fully inserted in the upper slot 13. As particularly illustrated in FIG. 7, a latch 14 locks the upper busbar B1 by stopping a shoulder B1b of the upper busbar B1.

The lower slot 15 is able to receive the end of the lower busbar B2. The lower slot 15 is generally perpendicular to the chamber’s axis A. The lower slot 15 preferably comprises at least one latch 16 able to selectively lock/unlock the end of the lower busbar B2, when the lower busbar B2 is fully inserted in the lower slot 15. As not illustrated, a latch 16 locks the lower busbar B2 by stopping a shoulder of the lower busbar B2.

According to another feature, when the upper busbar B1 is fully inserted in the upper slot 13, the axis A1 of the first hole H1 is aligned with the chamber’s axis A. When the lower busbar B2 is fully inserted in the lower slot 15, the axis A2 of the second hole H2 is aligned with the chamber’s axis A. This allows the screw 3, also aligned with the chamber’s axis A, to engage both holes H1, H2 and assemble both busbars B1, B2 while screwing the nut 4.

The disclosure is further directed to a method of using such an electrical junction 1 to join two busbars B1, B2. The method comprises the following steps. During a first step, a nut 4 is inserted into the bottom 10b of the chamber 10. During a second step, a second insulator 6 is placed and locked in the chamber 10, so as to secure the nut 4. During a third step, the end of an upper busbar B1 is inserted into the upper slot 13 of the housing 2. This is done until a stop is encountered at full insertion, where the at least one latch 14, if present, locks the upper busbar B1 in position. During a fourth step, a first insulator 5 is inserted in the chamber 10. The first insulator 5 is slid until the intermediate position. This inserts the lower part 5b in the first hole H1, thus securing the upper busbar B1 in the housing 2. During a fifth step, a lower busbar B2 is inserted into the lower slot 15 of the housing 2. This is done until a stop is encountered at full insertion, where the at least one latch 16, if present, locks the lower busbar B2 in position. During a sixth step, the first insulator 5 is slid to the final position. This inserts the lower part 5b in the second hole H2, thus securing the lower busbar B2, in addition to the upper busbar B1. During a seventh step, a screw 3 is inserted into the first insulator 5, along its axis A, and screwed into the nut 4.

While the invention has been described with reference to an exemplary embodiment(s), it may be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It may also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It may also be understood that the term “and/or” as used herein refers to and encompasses any and all possible combinations of one or more of the associated listed items. It may be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. An electrical junction, comprising:
a housing,
a screw; and
a nut, wherein the housing is able to receive an end of an upper busbar comprising a first hole along a first axis and an end of a lower busbar comprising a second hole along a second axis aligned with the first axis of the first hole, when busbars are engaged into the housing, both busbars being assembled by the screw engaging both holes and screwing the nut, so as to press busbars one against another, and wherein the junction further comprises a first insulator, generally cylindrical to be inserted in both holes and hollow to receive the screw, in order to inhibit any contact between the busbars and the screw.

2. The electrical junction according to claim 1, further comprising a second insulator comprising a third hole to be engaged by the screw, disposed between the nut and the lower busbar, in order to inhibit any contact between the lower busbar and the nut.

3. The electrical junction according to claim 2, wherein the first insulator and the second insulator are made of a PPSGF40 plastic material.

4. The electrical junction according to claim 1, wherein the housing comprises a generally cylindrical chamber with a top opening, able to receive the first insulator, the first insulator being able to slide with respect to the chamber, along the cylindrical chamber’s axis, parallel to the holes’ axis, when busbars are engaged into the housing, so that the first insulator can engage the holes, between an out position where the first insulator is removed from the housing and does not engage any of the holes, an intermediate position where the first insulator engages only the first hole of the upper busbar, and a final position where the first insulator engages both holes.

5. The electrical junction according to claim 4, wherein the housing and the first insulator comprise at least one latch and as many corresponding pits (9i, 9f) able to selectively engage/disengage, in order to lock the first insulator with respect to the housing in the intermediate position and/or in the final position.

6. The electrical junction according to claim 4, wherein the bottom of the cylindrical chamber is able to tightly receive the nut so as to inhibit its rotation along its axis, and the housing and the second insulator comprise at least one latch and as many corresponding pits able to selectively engage/disengage, to lock/unlock the second insulator with respect to the housing, in order to secure the nut in the bottom of the chamber.

7. The electrical junction according to claim 1, wherein the housing further comprises an upper slot able to receive the end of the upper busbar, the upper slot being generally perpendicular to the axis and comprising at least one latch able to selectively lock/unlock the end of the upper busbar, when fully inserted in the upper slot, and a lower slot able to receive the end of the lower busbar, the lower slot being generally perpendicular to the axis and comprising at least one latch able to selectively lock/unlock the end of the lower busbar, when fully inserted in the lower slot.

8. The electrical junction according to claim 7, wherein when the upper busbar is fully inserted in the upper slot, the first axis of the first hole is aligned with the axis, and when the lower busbar is fully inserted in the lower slot, the second axis of the second hole is aligned with the axis.

9. A method of assembling an electrical junction, comprising:
inserting a nut into the bottom of a cylindrical chamber;
placing and locking a second insulator in the cylindrical chamber;
inserting an upper busbar into an upper slot of a housing;
placing a first insulator in the chamber and sliding it to an intermediate position, in order to secure the upper busbar;
inserting a lower busbar into the lower slot of the housing;
sliding the first insulator to a final position, in order to secure the upper busbar and the lower busbar; and
inserting a screw into the first insulator and screwing it into the nut.
